(19) United States
(12) Patent Application Publication
(10) Pub. No.: US 2004/0127198 A1
(43) Pub. Date: Jul. 1, 2004

(54) Automatically changing a mobile device configuration based on environmental condition

(76) Inventors: James A. Roskind, Redwood City, CA (US); W. Karl Renner, Great Falls, VA (US)

Correspondence Address: FISH & RICHARDSON P.C., 1425 K STREET, N.W., 11TH FLOOR, WASHINGTON, DC, 20005-3500, US

(21) Appl. No.: 10/407,934

(22) Filed: Apr. 7, 2003

Related U.S. Application Data
(63) Continuation-in-part of application No. 10/330,543, filed on Dec. 30, 2002, now abandoned.

(51) Int. Cl. H04Q 7/20

(52) U.S. Cl. 455/412.2

(57) ABSTRACT

The described techniques automatically change the notification mode used by a mobile communications device to alert a user of an incoming communication to the mobile communications device. The notification mode is changed in response to a detected environmental condition. The mobile communications device monitors one or more environmental conditions, such as motion, light, sound, and heat, and compares the detected level of each environmental condition to a predetermined threshold. In response to the comparison result, the mobile communications device automatically adjusts the notification mode used to alert a user to an incoming communication. In some implementations, the notification mode change may be triggered only after the environmental condition persists for a predetermined interval of time. In some implementations, the types of automatic notification mode changes used may be based on a preference of a user and may be set through the use of an Internet protocol interface.

### CROSS REFERENCE TO RELATED APPLICATIONS

This application is a continuation-in-part of U.S. application Ser. No. 10/330,543, filed Dec. 30, 2002, and titled Automatically Changing a Mobile Device Configuration Based on Environmental Condition, which is hereby incorporated by reference in its entirety.

### TECHNICAL FIELD

This description relates to making changes to configuration information for a mobile communications device based on a detected change of an environmental condition.

### BACKGROUND

Various user-selectable configuration settings, such as a notification mode, are available for mobile communication devices. A mobile communications device user may prefer to select one or more of various notification modes based on the user's environment. For example, when a user is in a loud environment, such as a eating in a café, walking in an urban environment, or using public transportation, the user may prefer an audible notification mode, such that a ring or beep is used to alert the user of an incoming communication to the mobile communications device. Similarly, when a user is in a quiet environment, such as a business meeting, a movie theater, or a religious service, the user may prefer a haptic notification mode to invoke a vibration, or a visual notification mode to invoke a displayed message or a flashing light. The user manually changes the notification mode of the mobile communications device from one notification mode to a different notification mode. Thereafter, when the user returns to the original setting, the user manually initiates and completes the reconfiguration of the mobile communications device.

### SUMMARY

In one general aspect, a configuration of a mobile communications device may be automatically changed by monitoring sensory input at the mobile communications device that is reflective of an environmental condition for the mobile communications device. A level of an environmental condition of the mobile communications device is detected based on the sensory input. The detected level in the environmental condition is compared with a predetermined magnitude threshold for the environmental condition. In response to the result of the comparison, the notification mode of the mobile communications device is automatically adjusted.

Implementations may include one or more of the following features. For example, when the detected level exceeds or is less than the predetermined magnitude, the notification mode may be adjusted automatically. The detected level in the environmental condition may be compared with a second predetermined magnitude threshold for the environmental condition. When the detected level is less than the predetermined magnitude threshold and the detected level is greater than the second predetermined magnitude threshold, the notification mode may be automatically adjusted. The notification mode also may be automatically adjusted when the detected level is greater than the predetermined magnitude threshold and the detected level is less than the second predetermined magnitude threshold.

When a condition is detected, the notification mode may be automatically changed without user manipulation in response to the result of the comparison. When a condition is detected, the notification mode also may be changed in response to user confirmation. The user confirmation may include user manipulation. The notification mode may be changed from one of audible notification, visual notification, and haptic notification to another of audible notification, visual notification, and haptic notification. Adjusting the notification mode may include configuring the mobile communications device to alert a user to an incoming communication by using an audible mode, a visual mode, or a haptic mode. Adjusting the notification mode also may include configuring the mobile communications device to alert a user to an incoming communication by a notification mode other than an audible notification, other than a visual notification, or other than a haptic notification. An environmental condition may include one or more of motion, light, sound, and heat. When the detected level of motion is above a threshold of motion, the notification mode may be adjusted from a haptic notification to an audible notification. Similarly, when the detected level of motion is below a threshold of motion, and the notification mode may be adjusted from an audible notification to a haptic notification. A detected level of light is below a threshold of light, the notification mode may be adjusted to a visual notification. Similarly, a detected level of light is above a threshold of light, the notification mode may be adjusted from a visual notification to an audible notification or a haptic notification. The magnitude threshold for the environmental condition may be user configurable. The notification configuration associated with the mobile communications device may be automatically adjusted only when the detected environmental condition is experienced for a predetermined threshold time period. The threshold time period may be user configurable.

The notification mode of the mobile communications device may be automatically adjusted in response to a detected change in the environmental condition only when a predetermined condition is also met. A predetermined condition may be one or more of a predetermined time of day, a predetermined day of week, and a predetermined day of year.

In another general aspect, handling user-selectable configuration options for automatically adjusting notification configuration information includes providing an interface to user-selectable configuration options for enabling automatic adjustment of notification configuration for a mobile communications device in response to an environmental condition experienced at the mobile communications device. Access to the user-selectable configuration options for the mobile communications device may be enabled using the interface.

Implementations may include one or more of the features noted above and one or more of the following features. For example, the interface may be provided using an Internet Protocol network. The user-selectable configuration options may be modified. Modification of the user-selectable configuration options may include adding, updating, and deleting user-selectable configuration options.

Implementations of the techniques discussed above may include a method or process, an apparatus or system, or computer software on a computer-accessible medium. The details of one or more of the implementations are set forth in the accompanying drawings and description below. Other features will be apparent from the description and drawings, and from the claims.

### DESCRIPTION OF DRAWINGS

FIG. 1 is a block diagram illustrating a communications system capable of automatically changing the notification mode of a mobile communications device.

FIG. 2 is a block diagram of a mobile communications device capable of detecting an environmental condition and automatically changing the notification mode of the mobile communications device based on the detected environmental condition.

FIG. 3 is a flow chart of a process for detecting an environmental condition and automatically changing a notification mode based on the detected environmental condition.

FIG. 4 is a block diagram illustrating an exemplary computer system capable of implementing a process for handling mobile communications device notification mode configuration information.

FIG. 5 is a flow chart of a process for handling mobile communications device notification mode configuration information.

Like reference symbols in the various drawings indicate like elements.

### DETAILED DESCRIPTION

The described techniques automatically change the notification mode used by a mobile communications device to alert a user of an incoming communication to the mobile communications device. The notification mode is changed in response to a comparison of a detected level of an environmental condition with a predetermined magnitude threshold. When the predetermined magnitude threshold is met, the notification mode is changed only after the user is given an opportunity to accept an automatic notification change that has been proposed automatically, or to deny the automatic notification change that will occur otherwise.

In one example, the mobile communications device monitors one or more environmental conditions, such as motion, light, sound, and heat. The mobile communications device compares the level of each monitored environmental condition with a predetermined threshold for the type of environmental condition monitored. In response to the comparison result, the mobile communications device alerts a user of the mobile communications device that the notification change is to be changed. The user is given the opportunity to accept the automatic notification change that has been proposed, or to deny the automatic notification change that will occur otherwise (e.g., presses a key on the mobile communications device to accept the change or presses a different key to deny the notification change). When the user accepts the proposed notification change, the mobile communications device automatically adjusts the notification mode used to alert a user to an incoming communication or otherwise. For example, when the mobile communications device detects a sound level above a predetermined threshold (e.g., a relatively or absolutely loud environment), the mobile communications device changes the notification mode to a haptic mode, such as using a vibration to provide notifications for incoming communications and the like after the user accepts the proposed notification change. Similarly, when a mobile communications device detects a relatively or absolutely quiet environment because the sound level is less than a predetermined threshold, the mobile communications device changes the notification mode to a visual mode, such as a flashing light or displaying text, after the user has accepted the proposed notification change. Additionally or alternatively, the notification mode is adjusted automatically only when a change in an environmental condition persists for a predetermined interval of time.

Adjustments also may be made within a particular notification mode. For example, the volume of an audible notification mode may be changed based on a detected environmental sound level (i.e., the volume may be increased in response to a loud environment).

In some implementations, the types of automatic notification mode changes used may be based on a preference of a user. User preferences for the types of the notification mode changes to be made may be user-selectable or user-configurable, through the use of an Internet protocol (IP) interface or otherwise. The IP interface also may send the user preferences to the mobile communications device.

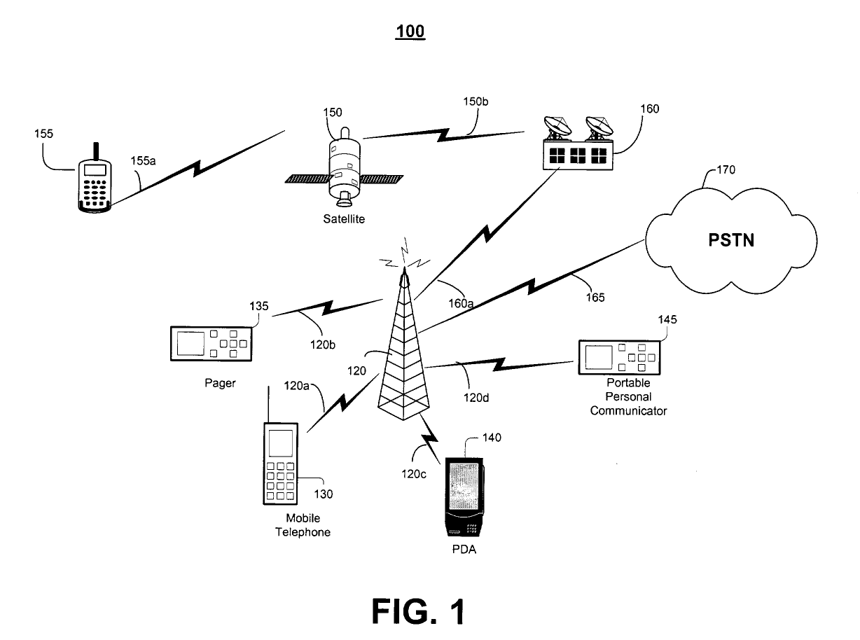

For illustrative purposes, FIG. 1 depicts a communications system 100 which is capable of directing communications between mobile communications devices, each of which is configured to implement techniques for automatically changing the notification mode based on a detected environmental condition. The illustrated communications system 100 may include additional or alternative mobile communications devices that are not shown, or the communications system 100 may include only a subset of the mobile communications devices that are shown.

The communications system 100 may include a mobile communications network or a satellite communications network. The communications system 100 may use a cellular tower 120 of a mobile services provider to communicate analog or digital signals 120a-120d between two or more remotely-located devices. The communications system 100 may use any technology, or combination of technologies, for transmitting signals. These technologies include, for example, Advanced Cellular telephone System (AMPS), Narrowband Advanced Cellular telephone Service (NAMPS), Frequency Shift Keying (FSK), Frequency Division Multiple Access (FDMA), Time Division Multiple Access (TDMA), and Code Division Multiple Access (CDMA), or any standard, such as Global System for Mobile communications (GSM) or Cellular Digital Packet Data (CDPD).

The mobile devices that communicate using the communications system 100 typically include a mobile telephone 130, a pager 135, a personal digital assistants (“PDA”) 140, and a portable personal communicator 145 (such as a mobile communicator), or other two-way messaging devices that are capable of communicating a variety of content, such as e-mail messages and instant messages. The communications system 100 may use a satellite 150 to enable communications between two or more remotely-located devices. The satellite 150 may communicate directly with a device, such as a satellite telephone 155, through signal 155a, or the satellite 150 may communicate indirectly with a particular mobile communications device, such as the mobile telephone 130, the pager 135, the PDA 140, or the portable personal communicator 145, by communicating signals 150b to a ground station 160 that communicates with the mobile communications devices through another communications network, such as a cellular tower 120. Some mobile devices, such as the mobile telephone 130 or the PDA 140, may be able to receive wireless communications from a cellular tower 120 or a satellite 150.

The communications system 110 may use a communications pathway 165 to connect with the Public Switched Telephone Network (PSTN) 170. The PSTN 170 is a telephone system that is capable of connecting a variety of devices, such as telephones, fax machines, or answering machines (none of which are shown), through a communications system that directs calls to a particular location, generally using land lines.

Each of the mobile communications devices 130-145 includes multiple notification modes to alert a user of an incoming communication. For example, the mobile telephone 130 includes a haptic mode that causes the mobile telephone 130 to vibrate when an incoming communication is received by the mobile telephone 130, an audible mode that causes the mobile telephone 130 to ring when an incoming communication is received, a visual mode that causes a light emitting diode (LED) to flash when an incoming communication is received, and another visual mode that causes scrolling text to be displayed when an incoming communication is received. The pager 135 and the portable personal communicator 145 both have notification modes that are the same as or similar to those of the mobile telephone 130. The PDA 140 includes a visual mode that causes scrolling text to be displayed when an incoming communication is received and an audible mode that causes a beep to be sounded when an incoming communication is received. The PDA 140 also may include a haptic mode to invoke a vibration.

Each of the mobile communications devices 130-145 is capable of automatically detecting one or more environmental conditions, such as motion, sound, light or heat. Each of the mobile communications devices 130-145 also is capable of effecting a change in one or more of the notification modes used to alert a user of an incoming communication automatically in response to one or more environmental conditions.

For example, a user of the pager 135 may desire to invoke a haptic mode when wearing the pager 135 such that the pager 135 alerts the user of an incoming communication by vibrating. The user may desire to invoke an audible mode when not wearing the pager 135 (e.g., when the pager 135 is nearby the sleeping user during the night) such that the pager 135 beeps to alert the user of an incoming communication. The pager 135 may detect one or more environmental conditions (such as an amount of body heat and/or the amount of motion) that are consistent with the pager no longer being worn by the user. In response to detected one or more environmental conditions, the pager 135 may change the notification mode used to alert the user from a haptic mode to an audible mode. Similarly, when the pager 135 detects one or more environmental conditions that are consistent with the pager being worn by the user (e.g., motion and/or body heat is detected), the pager 135 may change the notification mode used to alert the user from an audible mode to a haptic mode.

In another example, a user of the mobile telephone 130 may wish to manually turn off the audible notification mode and have the notification mode automatically adjusted to a ring once motion is detected. This type of automatic adjustment may be particularly useful, for example, when a user brings the mobile telephone 130 into a meeting during which the user desires that the mobile telephone 130 does not ring. Once the meeting has ended and the user moves the mobile telephone 130, the mobile telephone 130 detects motion and automatically adjusts the audible mode of the mobile telephone 130 to ring in response to receiving an incoming communication.

In some implementations, turning off all types of notification modes may be initiated by the user using an explicit command (e.g., pressing a particular key on the keypad of the mobile telephone 130) or by the user using an implicit command (e.g., placing the mobile telephone 130 face down on a table). Once the environmental condition of motion is detected, the mobile telephone 130 automatically activates the audible notification mode.

Enabling the automatic adjustment of the notification mode used by a mobile communications device may prove useful in various contexts. For example, the automatic adjustment may relieve the user from having to manually adjust one or more notification modes based on an environmental condition, which also may relieve the user of the burden of remembering to change or reset the notification mode.

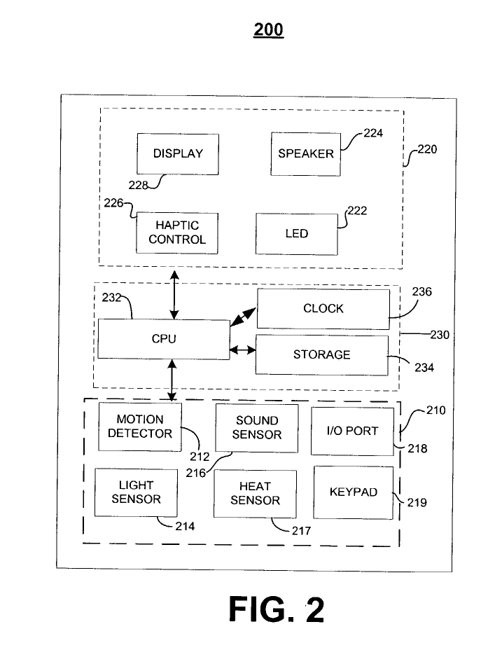

Referring to FIG. 2, a mobile communications device 200 is capable of automatically configuring the notification mode in response to detected environmental conditions. The mobile communications device 200 may be, for example, an implementation of the mobile telephone 130, the pager 135, the PDA 140, or the portable personal communicator 145, all of FIG. 1.

The mobile communications device 200 includes input components 210 to detect changes in environmental conditions or to enable input of data or selections to the mobile communications device. The input components 210 include a motion detector 212, a light sensor 214, a sound sensor 216, a heat sensor 217, an input/output (I/O) port 218, and a keypad 219. The motion detector 212 is capable of detecting the presence, absence, or degree of motion. The light sensor 214 is capable of discerning light intensity or lack thereof. The sound sensor 216 is capable of measuring the level of sound (e.g., the number of decibels). In some implementations, the sound sensor 216 may be able to detect ambient noise levels. For example, the sound sensor 216 or hardware/software (not shown) operating within the sound sensor 216 may distinguish background noise from human speech. The heat sensor 217 may include commercially-available hardware that is capable of detecting heat, e.g., the body heat of a user holding the device 200. The I/O port 218 enables communication with a remote computing device through the use of a cable or a cradle connection. In some implementations, an alternative or additional I/O port may enable wireless communications with another computing device. The keypad 219 allows a user to manually configure the one or more notification modes used by the mobile communications device 200 to alert the user of an incoming communication.

The mobile communications device 200 also includes output components 220 to alert a user to an incoming communication. The output components 220 include a LED 222 or other type of light indicator (not shown), a sound-producing device (e.g., a speaker) 224, a haptic control 226 for producing a vibration, and a display 228. The LED 222 may be used to provide visible notification, such as a flashing light, of an incoming communication. The speaker 224 may be used to provide an audible notification of an incoming communication. Examples of audible notifications may include rings, beeps, songs, or recorded messages, some or all of which may be played at various volumes. The haptic control 226 may be used to provide a vibrating notification of an incoming communication. The display 228 may be used to provide stationary and/or scrolling text to visually notify the user of an incoming communication.

The mobile communications device 200 also includes a processing component 230 that includes a central processing unit (CPU) 232, storage 234, and a clock 236. The CPU 232 monitors the environmental conditions by receiving and/or analyzing data from the input components 210. When the CPU 232 discerns an environmental condition above a predetermined threshold, the CPU 232 determines whether a notification mode change is necessary. The CPU 232 may make that determination based on, for example, notification configuration information accessed from storage 234, the magnitude or degree of the condition, and the period of time during which the change has persisted. The notification configuration information may include one or more notification modes set to be used for alerting a user to an incoming communication (e.g., the notification modes that are activated), other notification modes that may be used (e.g., the notification modes that are deactivated), and decision logic (or other executable instructions) for determining the notification modes to be selected or changed in response to particular environmental conditions. In some implementations, the notification configuration information also may include user preferences for activating or deactivating particular notification modes for particular types of environmental conditions.

The CPU 232 changes the notification mode to be used when an incoming communication is received. The CPU 232 may do so by modifying appropriate notification configuration information and/or by sending commands to change one or more settings on output components 220.

For example, the CPU 232 may detect that the level of sound exceeds a predetermined threshold by receiving and analyzing data from the sound sensor 216. The CPU 232 may determine that the level of ambient sound has increased and that the volume of the speaker 224 should be increased as a result of the environmental condition. To do so, the CPU 232 sends a command to speaker 224 to increase the volume control used by speaker 224 to provide an audible notification of an incoming communication. When a subsequent incoming communication is received, the audible notification is played at an increased volume based on the detected environmental condition and the automatic adjustment of the notification mode.

In another example, the CPU 232 may determine that the notification mode should be switched to a vibration mode by determining that the sound level exceeds a predetermined threshold and accessing notification configuration information from storage 234. The CPU 232 modifies the notification configuration information to indicate that the haptic control 236 should be activated and the audible mode should be deactivated. The CPU 232 sends a command to the haptic control 226 to activate the haptic control and sends a command to the speaker 224 to deactivate the speaker. When a subsequent incoming communication is received, the mobile communications device vibrates (and does not ring) to notify the user of the incoming communication.

In yet another example, the CPU 232 may determine that the notification mode should be switched to a vibration mode by determining that the temperature level is consistent with the body heat of a user holding the mobile communications device 200. The CPU 232 may change the notification mode to a haptic mode to alert the user to subsequent incoming communications.

In some implementations, the CPU 232 also may change the notification mode based on known scheduled information and the time of day and/or day of the week provided by a clock 236. For example, when a user has a meeting scheduled for a particular interval of time, the mobile communications device may automatically change the notification mode to an audible mode based on motion detected after the interval of time has passed. This may relieve the user from the burden of remembering to switch the notification mode from a haptic mode to an audible mode. This may be accomplished, for example, by having the CPU 232 search calendar information for the term “meeting” and, when the term “meeting” is found, determine the scheduled end time of the meeting. When the CPU 232 detects an environmental condition above a predetermined threshold (e.g., the environment is well-lit or a great deal of noise is present) at or relatively soon after the scheduled end time of the meeting, the CPU 232 changes the notification mode to an audible mode.

Additionally or alternatively, the CPU 232 may determine that the notification mode may be changed only in response to an environmental condition in combination with another type of criteria. For example, the CPU 232 may modify the notification mode only when an environmental condition changed during a predetermined time of day. Similarly, the CPU 232 may only invoke one or more particular notification mode adjustments based on the day, the day of the week, or the day of the year. This may be useful in helping to personalize or customize the notification change adjustments made to a user's schedule or habitual patterns.

In some implementations, the CPU 232 may modify the notification configuration information accessible in storage 234 to indicate the notification modes that should be activated when an incoming communication is received. When an incoming communication is received, the CPU 232 accesses the notification configuration information in storage 234 and sends the appropriate commands to each one of the output components 220 that should be used to notify the user.

In some implementations, the user may be able to selectively enable or disable the feature to automatically change the notification mode based on a detected environmental condition. Additionally or alternatively, a user may be able to set a preferred notification mode that overrides any attempts to change that particular mode. For example, a user may prefer to always be notified of an incoming communication using a haptic mode of vibration.

In some implementations, the CPU 232 may notify the user that the notification mode should be modified based on an environmental condition and only automatically modify the notification mode after receiving confirmation from the user. Typically, the confirmation from the user requires only a single user manipulation, such as a single button push using keypad 219. For example, when the CPU 232 determines that the notification mode should be modified, the CPU 232 displays text that describes a proposed notification mode change and requests user confirmation on display 228. The user may accept, reject, or modify the proposed notification mode change, for example, by using the keypad 219 to indicate the user's preference. When the user confirms the proposed notification mode change (e.g., by accepting the proposed change), the CPU 232 automatically modifies the notification mode. When the user does not confirm the proposed notification mode change (e.g., by rejecting the proposed change), the CPU 232 does not modify the notification mode.

Additionally or alternatively, the CPU 232 may modify the notification mode when an environmental condition is below a predetermined threshold. For example, the CPU 232 may detect a sound level below a predetermined threshold. This may be useful, for example, when the mobile communications device is in an environmental condition of relative or absolute quiet. The CPU 232 may change the notification mode to a haptic mode of vibration and/or a visual one of a flashing light.

In some implementations, the CPU 232 may modify the notification mode when an environmental condition is within a particular threshold range (e.g., greater than one threshold and less than a second, different threshold). For example, the CPU 232 may detect a sound level that is within a particular threshold range and increase the volume of an audible notification mode based on the sound level. The CPU 232 may turn off the audible notification mode when the sound level exceeds the second threshold (as when the maximum audible notification mode is insufficient to be heard over the sound level in the environment).

The CPU 232 may modify the notification mode in response to a combination of environmental conditions. The CPU 232 may modify more than one notification mode in response to an environmental condition, or a combination of environmental conditions. For example, when the sound level is below a particular sound threshold and the motion level is below a particular motion threshold, the CPU 232 may deactivate the audible notification mode and activate the haptic notification mode of vibration.

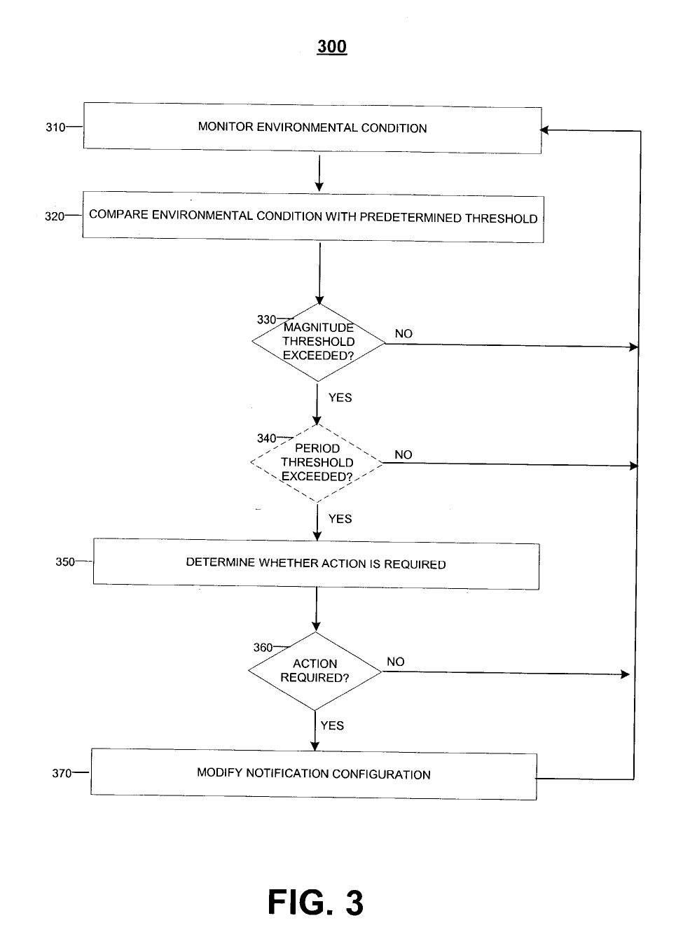

FIG. 3 illustrates a process 300 for detecting an environmental condition and automatically changing the notification mode of a mobile communications device based on the detected environmental condition. The process 300 may be performed by a mobile communications device, such as an implementation of the mobile telephone 130, the pager 135, the PDA 140, the portable personal communicator 145, or the satellite telephone 155, all of which have been previously described with respect to FIG. 1, or by the mobile communications device 200 of FIG. 2.

The process 300 begins with the mobile communications device monitoring the environment (step 310). This may be accomplished by using one or more of particular sensory devices to monitor a particular environmental condition. For example, a motion detector, such as motion detector 212 of FIG. 2, may be used to detect whether the mobile communications device is stationary or moving. A light sensor, such as the light sensor 214 of FIG. 2, may be used to detect the amount of light (e.g., dim light or bright light) around the mobile communications device. A sound sensor, such as the sound sensor 216 of FIG. 2, may detect the level of sound (e.g., as measured in decibels) or the type of sound (e.g., the amount of ambient noise) proximate to the mobile communications device.

The mobile communications device compares the level of the monitored environmental condition with a predetermined magnitude threshold for the type of environmental condition monitored (step 320). This may be accomplished, for example, using a table, a list, or other type of data collection that includes a predetermined threshold for each type of environmental condition monitored. The mobile communications device accesses the predetermined threshold for the type of environmental condition and compares the detected environmental condition level to a predetermined threshold.

When the predetermined threshold is not exceeded (step 330), the mobile communications device continues monitoring the environment (step 310) and does not change the notification mode for the mobile communications device in response to the detected environmental condition.

Optionally, when the mobile communications device determines that the detected environmental condition has exceeded the predetermined magnitude threshold (step 330), the mobile communications device determines whether the change has persisted or otherwise been experienced for a predetermined threshold period of time (step 340). The predetermined time period threshold indicates the shortest time interval (that is, a time period) during which the environmental condition must persist for a change to be made to the notification mode of the mobile communications device. In other words, the predetermined time period threshold indicates the minimum amount of time during which the environmental condition must persist to warrant a change in the notification mode. The same predetermined time period threshold may be used for all types of environmental conditions, or an individual predetermined time period threshold may be used for each monitored environmental condition. The use of a predetermined time period threshold may help improve the efficiency of the process 300 by reducing the number of brief environmental conditions that cause a change in the notification mode of the mobile communications device.

When the predetermined time period threshold is not exceeded, the mobile communications device continues monitoring the environment (step 310) and does not change the notification mode for the mobile communications device in response to the detected environmental condition.

In some implementations, the user may configure or otherwise determine the predetermined magnitude threshold for each type of environmental condition monitored (e.g., a user-configurable magnitude threshold). Similarly, the predetermined time period threshold also may be user-configurable in some implementations.

When the mobile communications device determines that the detected environmental condition has exceeded the predetermined threshold period of time (step 340), the mobile communications device determines whether action is required (step 350). The mobile communications device may determine whether action is required based on the type and/or degree of the detected environmental condition. This may be accomplished, for example, by accessing a table or list that indicates the notification mode settings to be set for a particular type of detected change, as illustrated in the table below.

| Detected conditions in | |
|---|---|
| environment of mobile | |
| communications device | Notification Modes Settings |
| Sound level condition-quiet | Haptic mode on |
| | Audible mode off |
| | Visual mode unchanged |
| Sound level condition-loud | Haptic mode off |
| | Audible mode on |
| | Visual mode on |
| Movement condition-stationary | Haptic mode on |
| | Audible mode off |
| | Visual mode on |
| Movement condition-moving | Haptic mode off |
| | Audible mode on |
| | Visual mode off |
| Light condition-dim | Haptic mode on |
| | Audible mode off |
| | Visual mode on |
| Light condition-bright | Haptic mode off |
| | Audible mode on |
| | Visual mode off |

For example, when a sound level of quiet is detected, the mobile communications device may determine that the haptic mode is to be on, the audible mode is to be off, and the visual mode is not to be modified. When the sound level detected is quiet, a user may prefer to be notified through the use of the haptic mode of vibration rather than through the use of the audible mode of a ring. Here, the mobile communications device does not modify the visual notification mode. This may be, for example, because the propriety of using a visual mode to notify the user may depend on the particular circumstances.

In some implementations, the action required may be determined based on which of several notification modes are active. For example, no action may be required to activate a visual mode that is currently active.

In some implementations, the action required may be determined based on a combination of environmental conditions, whether the environmental condition is below a predetermined threshold, whether the environmental condition is within a predetermined range of thresholds (e.g., above a particular threshold and below a different threshold) and/or whether the environmental condition is outside a predetermined range of thresholds (e.g., below a particular threshold and above a different threshold).

In some implementations, the mobile communications device may use configurable user-preferences that describe the processing logic for determining the particular types of notification mode changes that are to be made in certain specified conditions. This may be particularly useful when ambiguity is associated with automatically determining a preferred notification mode based on a few of environmental conditions monitored (e.g., only sound, motion, and light). For example, when a mobile communications device is located in a dark, quiet, and stationary environment, the user generally may prefer to receive a haptic notification mode in response to an incoming call. A haptic notification may be appropriate when the dark, quiet, stationary environment is associated with attending a theater performance or a business meeting. However, those same conditions also may occur at night, when the user is sleeping and when the user may prefer to use an audible notification mode to be alerted to an incoming call. The use of configurable user-preferences may help resolve some ambiguity associated with the determination of whether action is required. In particular, a user may associate a time of day and one or more environmental conditions with a change in the notification mode. Thus, a quiet, dim, and stationary environment during the daytime may result in an automatic change to a haptic notification mode, whereas the same environmental condition at night may result in the automatic change to an audible notification mode.

When the mobile communications device determines that no action is required (step 350), the mobile communications device continues monitoring the environment (step 310) without changing the notification mode configuration. When the mobile communications device determines that action is required (step 360), the mobile communications device modifies the notification mode configuration (step 370). This may be accomplished, for example, as described previously with respect to FIG. 2.

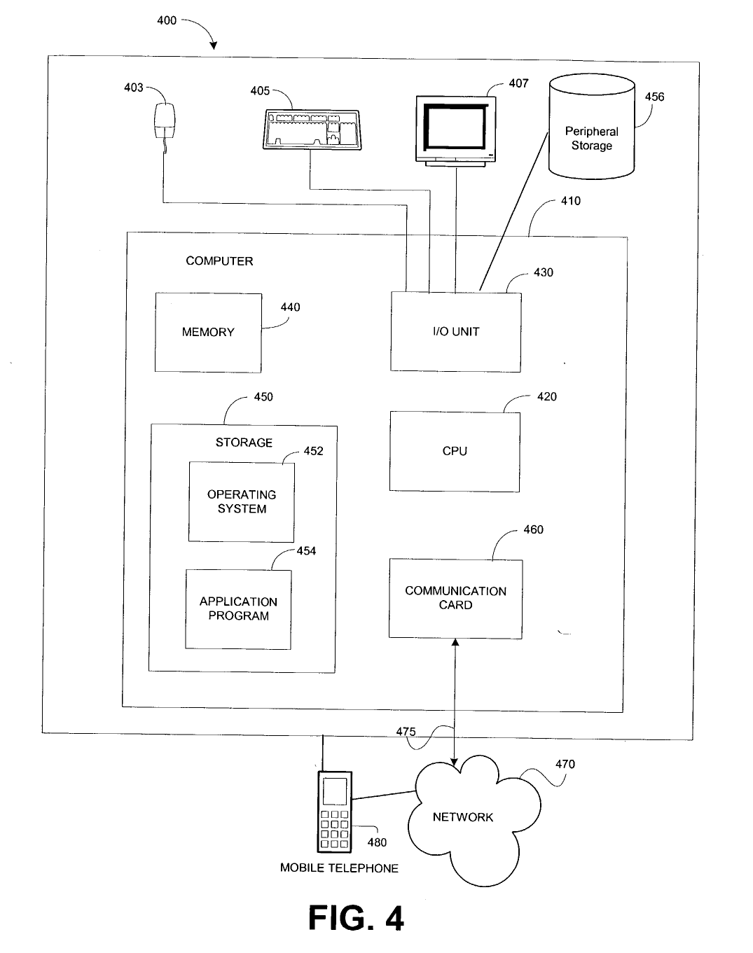

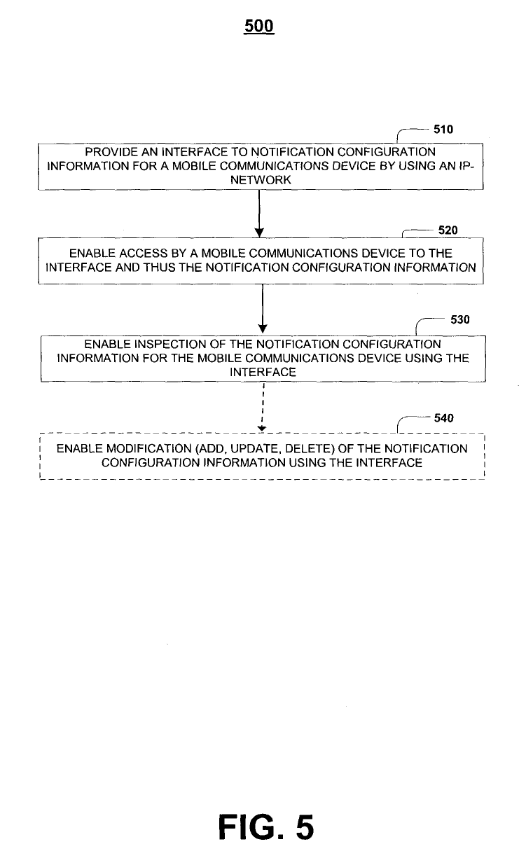

Referring to FIGS. 4 and 5, another aspect of the overall implementation involves handling notification configuration information for the mobile communications device by accessing an IP network. FIG. 4 depicts a programmable system 400 for handling notification configuration information for a mobile communications device. The programmable system 400 includes a variety of input/output (I/O) devices (e.g., mouse 403, keyboard 405, and display 407) and a computer 410 having a CPU 420, an I/O unit 430, a memory 440, and a data storage device 450. Data storage device 450 may store machine-executable instructions, data, and various programs, such as an operating system 452 and one or more application programs 454, for implementing a process for handling notification configuration information, all of which may be processed by CPU 420. Each computer program may be implemented in a high-level procedural or object-oriented programming language, or in assembly or machine language if desired; and, in any case, the language may be a compiled or interpreted language. Data storage device 450 may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; and Compact Disc Read-Only Memory (CD-ROM).

The programmable system 400 may include one or more peripheral online storage devices 456 for storing notification configuration information. Peripheral online storage device 456 may use any storage media (including magnetic, optical or solid state storage media) or any type of storage device (including a drive, a microdrive, a compact disc (CD), a recordable CD (CD-R), a rewriteable CD (CD-RW), a flash memory, or a solid-state floppy disk card (SSFDC)).

The computer 410 also may include a communications card or device 460 (e.g., a modem and/or a network adapter) for exchanging data with a network 470 using a communications link 475 (e.g., a telephone line, a wireless network link, a wired network link, or a cable network). Examples of the network 470 include the Internet, the World Wide Web, WANs, LANs, analog or digital wired and wireless telephone networks (e.g., ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Loop), HDSL (“High bit-rate Digital Subscriber Line”), and VDSL (“Very high bit-rate Digital Subscriber Line)), radio, television, cable, satellite, and/or any other delivery mechanism for carrying data.

Other examples of system 400 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

The computer 410 may use the communications link 475 to communicate over the network 470 with a mobile communications device 480. As shown, the mobile communications device 480 may be, for example, a mobile telephone, such as an implementation of the mobile telephone 130 of FIG. 1. The mobile communications device 480 also may be another type of a mobile communications device (such as a pager, a PDA, or a portable personal communicator as described above with respect to FIG. 1 or a mobile communications device 200 such as discussed with respect to FIG. 2). The computer 410 may receive notification configuration information from a user using one or more of input/output devices 403 and 405 and may send the received notification configuration information to mobile communications device 480. The mobile communications device then may store the received notification configuration information.

FIG. 5 illustrates a process 500 for handling notification configuration information for the mobile communications device by accessing an IP network. The process 500 generally is performed by a mobile communications device capable of accessing an IP network, such as the programmable system 400 of FIG. 4. In some implementations, one type of a mobile communications device, such as an implementation of the PDA 140, handles configuration for another type of a mobile communications device, such as an implementation of the mobile telephone 130 of FIG. 1. The process 500 may be particularly advantageous when the mobile communications device has a limited keypad, such as a mobile telephone, and/or the user-selectable or the user-configurable parameters for changing notification modes are many or complex.

The process 500 to handle notification configuration information for the mobile communications device includes using an IP network interface to provide access to user-selectable parameters for automatically adjusting notification configuration information for a mobile communications device (step 510). The user-selectable parameters may include identifying the notification mode changes that should be made in response to identified environmental conditions for a particular mobile communications device. The user-selectable parameters also may include an association of the time of day and/or the day of the week at which identified notification mode changes should be made.

The user-selectable parameters may be stored in a table or a list that identifies one or more type of changes to be made in response to identified environmental conditions (as described previously with respect to step 350 in FIG. 3). Additionally, one or more user-selectable parameters may be associated with a time period and/or a day of the week on which the condition occurs. This may permit a user to preconfigure a mobile communications device to automatically change to only a haptic mode in response to a quiet, stationary condition during a weekly religious service and to change to an audible mode when a loud, brightly-lit, moving environment is perceived and after the time period in which the religious service generally occurs has ended.

In some implementations, user-configurable options may be identified using an interface that provides a calendar for the ease of identifying times, some of which may be recurring and some of which may not be recurring, during which particular environmental conditions are to trigger a change in the notification mode of the mobile communications device. For example, a business meeting may be identified using a calendar interface and the mobile communications device may be able to more accurately change the notification mode based on movement in view of the scheduled start and end time of the meeting.

Additionally or alternatively, Boolean logic may be used to describe the notification mode changes that are to be triggered by particular combinations of one or more environmental conditions, one or more current notification mode settings, the time of day, and/or the day of the week.

A mobile communications device may be identifiable (such as by using an IP address, a MAC address or other device identifier, or a telephone number) so as to enable notification configuration information to be sent to an identified communications device based on execution of an adjustment of notification configuration information settings.

Using an IP network interface to provide access to user-selectable options for automatically adjusting notification configuration information for a mobile communications device may allow convenient access to the options currently selected and convenient modification by a user of the selected options. In contrast, identifying and modifying user-configurable options to a process for automatically changing notification configuration information based on environmental conditions may be burdensome to perform using only a limited keypad associated with a mobile communications device. Leveraging such an IP network interface and identifiers associated with one or more mobile communications devices (e.g., an 1P-address or telephone number), the user-configurable options for automatically adjusting notification configuration information for a mobile communications device based on a detected environmental condition for one or more particular mobile communications device may be accessed and/or modified.

The ability to use an IP network to gain access to, and modify, user-selectable options may be convenient. For example, the ability to modify configurable options using an IP network interface may be useful, particularly to a user who desires to update the configuration notification information on a mobile device with limited input capability (e.g., a mobile telephone) while away from a desktop computer upon which configuration software resides. The IP network interface may free the user from the burden of carrying the software and wire (or other connection) to update configuration information on the mobile device while away from a desktop computer.

The process 500 enables access to user-selectable options for automatically adjusting notification configuration information for a mobile communications device using an interface (step 520) and enables inspection of the user-selected options for automatically adjusting notification configuration information for a mobile communications device using the interface (step 530).

The process 500 also may include enabling modification of the user-selection options using the interface (step 540). The modification may include one or more of adding, deleting, or updating user-selectable options.

Although the techniques have been described as automatically changing a notification mode or notification modes based on one or more environmental conditions, in some implementations other configuration settings may be changed based on one or more detected environmental conditions. For example, the volume setting on a speaker may be changed based on the level of sound in the environment of a mobile communications device. Similarly, the brightness used for a display may be adjusted based on the level of light in the environment.

Implementations may include a method or process, an apparatus or system, or computer software on a computer medium. It will be understood that various modifications may be made that still fall within the following claims. For example, advantageous results still could be achieved if steps of the disclosed techniques were performed in a different order and/or if components in the disclosed systems were combined in a different manner and/or replaced or supplemented by other components.

What is claimed is:

1. A method for automatically changing the configuration of a mobile communications device, the method comprising:
monitoring sensory input at the mobile communications device that is reflective of an environmental condition for the mobile communications device;
detecting a level in the environmental condition of the mobile communications device based on the sensory input;
comparing the detected level in the environmental condition with a predetermined magnitude threshold for the environmental condition; and
in response to a result of the comparison, automatically adjusting a notification mode of the mobile communications device.

2. The method of claim 1 wherein the notification mode is automatically adjusted when the result of the comparison indicates that the detected level exceeds the predetermined magnitude threshold.

3. The method of claim 1 wherein the notification mode is automatically adjusted when the result of the comparison indicates that the detected level is less than the predetermined magnitude threshold.

4. The method of claim 1 further comprising comparing the detected level in the environmental condition with a second predetermined magnitude threshold for the environmental condition,
wherein the notification mode is automatically adjusted when the detected level is less than the predetermined magnitude threshold but greater than the second predetermined magnitude threshold.

5. The method of claim 1 further comprising comparing the detected level in the environmental condition with a second predetermined magnitude threshold for the environmental condition,
wherein the notification mode is automatically adjusted when the detected level is greater than the predetermined magnitude threshold but less than the second predetermined magnitude threshold.

6. The method of claim 1 wherein the notification mode is automatically adjusted without user manipulation in response to the result of the comparison.

7. The method of claim 1 wherein the notification mode is automatically adjusted by changing the notification mode from one of an audible notification, a visual notification, and a haptic notification to another of the audible notification, the visual notification, and the haptic notification.

8. The method of claim 7 wherein adjusting the notification mode comprises configuring the mobile communications device to alert a user of an incoming communication by using an audible notification.

9. The method of claim 7 wherein adjusting the notification mode comprises configuring the mobile communications device to alert a user of an incoming communication by using a visual notification.

10. The method of claim 7 wherein adjusting the notification mode comprises configuring the mobile communications device to alert a user of an incoming communication by using a haptic notification.

11. The method of claim 7 wherein adjusting the notification mode comprises configuring the mobile communications device to alert a user of an incoming communication by a notification mode other than an audible notification.

12. The method of claim 7 wherein adjusting the notification mode comprises configuring the mobile communications device to alert a user of an incoming communication by a notification mode other than a visual notification.

13. The method of claim 7 wherein adjusting the notification mode comprises configuring the mobile communications device to alert a user of an incoming communication by a notification mode other than a haptic notification.

14. The method of claim 1 wherein the environmental condition comprises one or more of motion, light, sound, and heat.

15. The method of claim 14 wherein:
the environmental condition is motion,
the detected level of motion is above a threshold of motion, and
adjusting the notification mode comprises configuring the mobile communications device from a haptic notification to an audible notification in response to the level of motion being above the threshold of motion.

16. The method of claim 14 wherein:
the environmental condition is motion,
the detected level of motion is below a threshold of motion, and
adjusting the notification mode comprises configuring the mobile communications device from an audible notification to a haptic notification or a visual notification in response to the level of motion being below the threshold of motion.

17. The method of claim 14 wherein:
the environmental condition is light,
the detected level of light is below a threshold of light, and adjusting the notification mode comprises configuring the mobile communications device to a visual notification in response to the level of light being below the threshold of light.

18. The method of claim 14 wherein:
the environmental condition is light,
the detected level of light is above a threshold of light, and
adjusting the notification mode comprises configuring the mobile communications device from a visual notification to an audible notification or a haptic notification in response to the level of light being above the threshold of light.

19. The method of claim 1 wherein the magnitude threshold for the environmental condition is user configurable.

20. The method of claim 1 further comprising:
determining whether the detected environmental condition is experienced for a predetermined threshold time period; and
only when the detected environmental condition is experienced for the predetermined threshold time period, adjusting the notification configuration associated with the mobile communications device based on the detected environmental condition.

21. The method of claim 20 wherein the threshold time period is user configurable.

22. The method of claim 1 automatically adjusting the notification mode of the mobile communications device comprises automatically adjusting the notification mode of the mobile communications device in response to a detected environmental condition only when a predetermined condition also is met.

23. The method of claim 22 wherein the predetermined condition comprises one or more of a predetermined time of day, a predetermined day, a predetermined day of week, and a predetermined day of the year.

24. The method of claim 1 wherein the notification mode is automatically changed in response to user confirmation when the environmental condition is detected.

25. The method of claim 24 wherein the user confirmation comprises user manipulation.

26. A method for handling user-selectable configuration options for automatically adjusting notification configuration information, the method comprising:
providing an interface to user-selectable configuration options for enabling automatic adjustment of a notification configuration for a mobile communications device in response to an environmental condition experienced at the mobile communications device; and
enabling access to the user-selectable configuration options for the mobile communications device using the interface.

27. The method of claim 26 wherein providing the interface comprises using an Internet Protocol network to provide an interface to user-selectable configuration options.

28. The method of claim 26 wherein the environmental condition comprises one or more of motion, light, sound, and heat.

29. The method of claim 26 wherein enabling automatic adjustment of the notification configuration comprises enabling the automatic adjustment of the notification configuration to alter the user of an incoming communication by using an audible notification.

30. The method of claim 26 wherein enabling automatic adjustment of the notification configuration comprises enabling the automatic adjustment of the notification configuration to alter the user of an incoming communication by using an visual notification.

31. The method of claim 26 wherein enabling automatic adjustment of the notification configuration comprises enabling the automatic adjustment of the notification configuration to alter the user of an incoming communication by using an haptic notification.

32. The method of claim 26 further comprising enabling modification of the user-selectable configuration options to enable automatic adjustment of the notification configuration for the mobile communications device using the interface.

33. The method of claim 26 wherein the modification of the user-selectable configuration options to enable automatic adjustment of the notification configuration information for the mobile communications device comprises adding a user-selectable configuration option.

34. The method of claim 33 wherein the modification of the user-selectable configuration options to enable automatic adjustment of the notification configuration information for the mobile communications device comprises deleting a user-selectable configuration option.

35. The method of claim 33 wherein the modification of the user-selectable configuration options to enable automatic adjustment of the notification configuration information for the mobile communications device comprises updating a user-selectable configuration option.

36. A computer-readable medium or propagated signal having embodied thereon a computer program configured to automatically change the configuration of a mobile communications device, the medium or signal comprising one or more code segments configured to:
monitor sensory input at the mobile communications device that is reflective of an environmental condition for the mobile communications device;
detect a level in the environmental condition of the mobile communications device based on the sensory input;
compare the detected level in the environmental condition with a predetermined magnitude threshold for the environmental condition; and
in response to a result of the comparison, automatically adjust a notification mode of the mobile communications device.

37. The medium or signal of claim 36 wherein the one or more code segments are configured to automatically adjust the notification mode when the result of the comparison indicates that the detected level exceeds the predetermined magnitude threshold.

38. The medium or signal of claim 36 wherein the one or more code segments are configured to automatically adjust the notification mode when the result of the comparison indicates that the detected level is less than the predetermined magnitude threshold.

39. The medium or signal of claim 36 wherein the one or more code segments are further configured to compare the detected level in the environmental condition with a second predetermined magnitude threshold for the environmental condition, and automatically adjust the notification mode when the detected level is less than the predetermined magnitude threshold but greater than the second predetermined magnitude threshold.

40. The medium or signal of claim 36 wherein the one or more code segments are configured to compare the detected level in the environmental condition with a second predetermined magnitude threshold for the environmental condition, and automatically adjust the notification mode when the detected level is greater than the predetermined magnitude threshold but less than the second predetermined magnitude threshold.

41. The medium or signal of claim 36 wherein the one or more code segments configured to automatically adjust the notification mode without user manipulation in response to the result of the comparison.

42. The medium or signal of claim 36 wherein the one or more code segments are configured to automatically adjust the notification mode by changing the notification mode from one of an audible notification, a visual notification, and a haptic notification to another of the audible notification, the visual notification, and the haptic notification.

43. The medium or signal of claim 42 wherein the one or more code segments configured to adjust the notification mode comprise one or more code segments configured to configure the mobile communications device to alert a user of an incoming communication by using an audible notification.

44. The medium or signal of claim 42 wherein the one or more code segments configured to adjust the notification mode comprise one or more code segments configured to configure the mobile communications device to alert a user of an incoming communication by using a visual notification.

45. The medium or signal of claim 42 wherein the one or more code segments configured to adjust the notification mode comprise one or more code segments configured to configure the mobile communications device to alert a user of an incoming communication by using a haptic notification.

46. The medium or signal of claim 42 wherein the one or more code segments configured to adjust the notification mode comprise one or more code segments configured to configure the mobile communications device to alert a user of an incoming communication by a notification mode other than an audible notification.

47. The medium or signal of claim 42 wherein the one or more code segments configured to adjust the notification mode comprise one or more code segments configured to configure the mobile communications device to alert a user of an incoming communication by a notification mode other than an visual notification.

48. The medium or signal of claim 42 wherein the one or more code segments configured to adjust the notification mode comprise one or more code segments configured to configure the mobile communications device to alert a user of an incoming communication by a notification mode other than a haptic notification.

49. The medium or signal of claim 36 wherein the environmental condition comprises one or more of motion, light, sound, and heat.

50. The medium or signal of claim 49 wherein:
the one or more code segments configured to detect the level in the environmental condition comprise one or more code segments configured to detect a level of motion, and
the one or more code segments are configured to configure the mobile communications device from a haptic notification to an audible notification in response to the level of motion being above the threshold of motion.

51. The medium or signal of claim 49 wherein:
the one or more code segments configured to detect the level in the environmental condition comprise one or more code segments configured to detect a level of motion, and
the one or more code segments are configured to configure the mobile communications device from an audible notification to a haptic notification or a visual notification in response to the level of motion being below the threshold of motion.

52. The medium or signal of claim 49 wherein:
the one or more code segments configured to detect the level in the environmental condition comprise one or more code segments configured to detect a level of light, and
the one or more code segments are configured to configure the mobile communications device to a visual notification in response to the level of light being below the threshold of light.

53. The medium or signal of claim 49 wherein:
the one or more code segments configured to detect the level in the environmental condition comprise one or more code segments configured to detect a level of light, and
the one or more code segments are configured to configure the mobile communications device from a visual notification to an audible notification or a haptic notification in response to the level of light being above the threshold of light.

54. The medium or signal of claim 36 wherein the magnitude threshold for the environmental condition is user configurable.

55. The medium or signal of claim 36 wherein the one or more code segments are further configured to:
determine whether the detected environmental condition is experienced for a predetermined threshold time period; and
adjust the notification configuration associated with the mobile communications device based on the detected environmental condition only when the detected environmental condition is experienced for the predetermined threshold time period.

56. The medium or signal of claim 55 wherein the threshold time period is user configurable.

57. The medium or signal of claim 36 wherein the one or more code segments configured to automatically adjust the notification mode of the mobile communications device comprise one or more code segments configured to automatically adjust the notification mode of the mobile communications device in response to a detected environmental condition only when a predetermined condition also is met.

58. The medium or signal of claim 57 wherein the predetermined condition comprises one or more of a predetermined time of day, a predetermined day, a predetermined day of week, and a predetermined day of the year.

59. The medium or signal of claim 36 wherein the one or more code segments are configured to automatically adjust the notification mode in response to user confirmation when the environmental condition is detected.

60. The medium or signal of claim 59 wherein the user confirmation comprises user manipulation.

61. A computer-readable medium or propagated signal having embodied thereon a computer program configured to handle user-selectable configuration options for automatically adjusting notification configuration information, the medium or signal comprising one or more code segments configured to:
provide an interface to user-selectable configuration options for enabling automatic adjustment of a notification configuration for a mobile communications device in response to an environmental condition experienced at the mobile communications device; and
enable access to the user-selectable configuration options for the mobile communications device using the interface.

62. The medium or signal of claim 61 wherein the one or more code segments configured to provide the interface comprise one or more code segments configured to use an Internet Protocol network to provide an interface to user-selectable configuration options.

63. The medium or signal of claim 61 wherein the environmental condition comprises one or more of motion, light, sound, and heat.

64. The medium or signal of claim 61 wherein the one or more code segments configured to enable automatic adjustment of the notification configuration comprise one or more code segments configured to enable the automatic adjustment of the notification configuration to alter the user of an incoming communication by using an audible notification.

65. The medium or signal of claim 61 wherein the one or more code segments configured to enable automatic adjustment of the notification configuration comprise one or more code segments configured to enable the automatic adjustment of the notification configuration to alter the user of an incoming communication by using an visual notification.

66. The medium or signal of claim 61 wherein the one or more code segments configured to enable automatic adjustment of the notification configuration comprise one or more code segments configured to enable the automatic adjustment of the notification configuration to alter the user of an incoming communication by using an haptic notification.

67. The medium or signal of claim 61 wherein the one or more code segments are further configured to enable modification of the user-selectable configuration options to enable automatic adjustment of the notification configuration for the mobile communications device using the interface.

68. The medium or signal of claim 61 wherein the one or more code segments configured to enable modification of the user-selectable configuration options to enable automatic adjustment of the notification configuration information for the mobile communications device comprise one or more code segments configured to add a user-selectable configuration option.

69. The medium or signal of claim 68 wherein the one or more code segments configured to enable modification of the user-selectable configuration options to enable automatic adjustment of the notification configuration information for the mobile communications device comprise one or more code segments configured to delete a user-selectable configuration option.

70. The medium or signal of claim 68 wherein the one or more code segments configured to enable modification of the user-selectable configuration options to enable automatic adjustment of the notification configuration information for the mobile communications device comprise one or more code segments configured to update a user-selectable configuration option.

71. An apparatus for automatically changing the configuration of a mobile communications device, the apparatus comprising a processor connected to one or more input components and one or more output components, wherein the processor is configured to:
monitor sensory input at the mobile communications device that is reflective of an environmental condition for the mobile communications device;
detect a level in the environmental condition of the mobile communications device based on the sensory input;
compare the detected level in the environmental condition with a predetermined magnitude threshold for the environmental condition; and
in response to a result of the comparison, automatically adjust a notification mode of the mobile communications device.

72. The apparatus of claim 71 wherein the processor is configured to automatically adjust the notification mode when the result of the comparison indicates that the detected level exceeds the predetermined magnitude threshold.

73. The apparatus of claim 71 wherein the processor is configured to automatically adjust the notification mode when the result of the comparison indicates that the detected level is less than the predetermined magnitude threshold.

74. The apparatus of claim 71 wherein the processor is further configured to:
compare the detected level in the environmental condition with a second predetermined magnitude threshold for the environmental condition, and
automatically adjust the notification mode when the detected level is less than the predetermined magnitude threshold but greater than the second predetermined magnitude threshold.

75. The apparatus of claim 71 wherein the processor is further configured to:
compare the detected level in the environmental condition with a second predetermined magnitude threshold for the environmental condition; and
automatically adjust the notification mode when the detected level is greater than the predetermined magnitude threshold but less than the second predetermined magnitude threshold.

76. The apparatus of claim 71 wherein the processor is configured to automatically adjust the notification mode without user manipulation in response to the result of the comparison.

77. The apparatus of claim 71 wherein the processor is configured to automatically adjust the notification mode by changing the notification mode from one of an audible notification, a visual notification, and a haptic notification to another of the audible notification, the visual notification, and the haptic notification.

78. The apparatus of claim 77 wherein the processor is configured to configure the mobile communications device to alert a user of an incoming communication by an audible notification.

79. The apparatus of claim 77 wherein the processor is configured to configure the mobile communications device to alert a user of an incoming communication by a visual notification.

80. The apparatus of claim 77 wherein the processor is configured to configure the mobile communications device to alert a user of an incoming communication by a haptic notification.

81. The apparatus of claim 77 wherein the processor is configured to configure the mobile communications device to alert a user of an incoming communication by a notification mode other than an audible notification.

82. The apparatus of claim 77 wherein the processor is configured to configure the mobile communications device to alert a user of an incoming communication by a notification mode other than a visual notification.

83. The apparatus of claim 77 wherein the processor is configured to configure the mobile communications device to alert a user of an incoming communication by a notification mode other than a haptic notification.

84. The apparatus of claim 71 wherein the one or more input components are configured to monitor one or more of motion, light, sound, and heat.

85. The apparatus of claim 84 wherein the processor is further configured to:
detect a level of motion, and
configure the mobile communications device from a haptic notification to an audible notification in response to the level of motion being above the threshold of motion.

86. The apparatus of claim 84 wherein the processor is further configured to:
detect a level of motion, and
configure the mobile communications device from an audible notification to a haptic notification or a visual notification in response to the level of motion being below the threshold of motion.

87. The apparatus of claim 84 wherein the processor is further configured to:
detect a level of light, and
configure the mobile communications device to a visual notification in response to the level of light being below the threshold of light.

88. The apparatus of claim 84 wherein the processor is further configured to:
detect a level of light, and
configure the mobile communications device from a visual notification to an audible notification or a haptic notification in response to the level of light being above the threshold of light.

89. The apparatus of claim 71 wherein the magnitude threshold for the environmental condition is user configurable.

90. The apparatus of claim 71 wherein the processor is further configured to:
determine whether the detected environmental condition is experienced for a predetermined threshold time period, and
adjust the notification configuration associated with the mobile communications device based on the detected environmental condition only when the detected environmental condition is experienced for the predetermined threshold time period.

91. The apparatus of claim 90 wherein the threshold time period is user configurable.

92. The apparatus of claim 71 wherein the processor is further configured to automatically adjust the notification mode of the mobile communications device in response to a detected environmental condition only when a predetermined condition also is met.

93. The apparatus of claim 92 wherein the predetermined condition comprises one or more of a predetermined time of day, a predetermined day, a predetermined day of week, and a predetermined day of the year.

94. The apparatus of claim 71 wherein the processor is configured to automatically adjust the notification mode in response to user confirmation when the environmental condition is detected.

95. The apparatus of claim 94 wherein the user confirmation comprises user manipulation.

96. A system for handling user-selectable configuration options for automatically adjusting notification configuration information, the system comprising a processor connected to a storage device and one or more input/output devices, wherein the processor is configured to:
provide an interface to user-selectable configuration options for enabling automatic adjustment of a notification configuration for a mobile communications device in response to an environmental condition experienced at the mobile communications device; and
enable access to the user-selectable configuration options for the mobile communications device using the interface.

97. The system of claim 96 wherein the processor is configured to use an Internet Protocol network to provide an interface to user-selectable configuration options.

98. The system of claim 96 wherein the environmental condition comprises one or more of motion, light, sound, and heat.

99. The system of claim 96 wherein the processor is configured to enable the automatic adjustment of the notification configuration to alter the user of an incoming communication by an audible notification.

100. The system of claim 96 wherein the processor is configured to enable the automatic adjustment of the notification configuration to alter the user of an incoming communication by a visual notification.

101. The system of claim 96 wherein the processor is configured to enable the automatic adjustment of the notification configuration to alter the user of an incoming communication by a haptic notification.

102. The system of claim 96 wherein the processor is further configured to enable modification of the user-selectable configuration options to enable automatic adjustment of the notification configuration for the mobile communications device using the interface.

103. The system of claim 96 wherein the processor is configured to enable the addition of a user-selectable configuration option.

104. The system of claim 103 wherein the processor is configured to enable the deletion of a user-selectable configuration option.

105. The system of claim 103 wherein the processor is configured to enable the update of a user-selectable configuration option.
